(19) United States
(12) Patent Application Publication
(10) Pub. No.: US 2019/0340495 A1
(43) Pub. Date: Nov. 7, 2019

(54) Path Stack Neural Network AI

(71) Applicant: Linden David Aites, Pittsburgh, PA (US)

(72) Inventor: Linden David Aites, Pittsburgh, PA (US)

(21) Appl. No.: 15/968,767

(22) Filed: May 2, 2018

(51) Int. Cl. G06N 3/04; G06N 3/08; A63F 13/56

(52) U.S. Cl. CPC G06N 3/0427; A63F 13/56; G06N 3/08

(57) ABSTRACT

This is primarily a path finding algorithm using neural networks. The core idea is using a “path stack” of values as well as various modifiers to improve upon the basic ideas of artificial neural networks. Each layer within the stack of numbers represents information about the space that a given actor is existing in. These are modified by things such as personality or situation modifiers to weight the given cells strongly or weakly. This can represent perceived conditions, memories of previous information, or other modifications to the area. The given information within the path stack may be used for other purposes such as choosing an action, acquiring a target, or communicating information to other actors. The use of artificial neural networks and “stacks” of floating point numbers with modifiers will allow for the creation of more responsive and less predictable AI. While its primarily intention is to be useful in turn-based computer games it is by no means limited to this; any information that may be abstracted into a set of individual cells or coordinates can be utilized in such an algorithm.

The algorithm described can also serve to simplify the creation of artificial intelligence for a given game. Rather than creating individual AI scripts for each given actor more generic code may be created and given a set of “personality modifiers” that will alter how the actor responds to any given information that it has been given access to.

### BACKGROUND

As computers have advanced so have computer games. Various theoretical computer science concepts have been applied to the creation of computer games as well. Meanwhile the advancement in computer processors has allowed for not only more complex games to be made but also more advanced game AI. Neural networks in particular have had a vast number of applications in nearly every field; they are obviously useful for game AI as well. Creating less predictable and more intelligent AI can increase the challenge for the player as well as create worlds that seem more organic and alive.

The AI in computer games is notorious for often being predictable and not particularly adaptable. As more processing power is available for computing AI algorithms more complex algorithms as well as game spaces can be created. The use of artificial neural networks for path finding allows for a variety of paths to be calculated as well as more complex, informed decision making. Such use will also allow for more abstract AI that requires less information upon creation to be made. Such AI will also be able to explore its surroundings rather than be stuck a set of previously programmed instructions. Rather than following a chosen set of nodes through a given path such AI would also be able to pick fuzzier, less specific paths and adapt to them as the situation requires.

While this is intended for computer games path finding algorithms are universally useful.

### SUMMARY

The “path stack” concept is core to this algorithm especially in the case of path finding. This is a set of numbers “stacked” together for a given cell that are multiplied by various modifiers and then totaled to give the value of any given stack. A path is then calculated out of the best seen values. Alternatively this can be used to affect decision making for a given actor in a given space; the information can be used by a decision-making algorithm to decide just what to do.

Any space that can be reduced to an array or a set of coordinates can utilize this algorithm. The number of dimensions is not limited and varies only in the application.

The values and modifiers can be altered using traditional artificial neural network learning algorithms. Various cells can be reinforced if desired or have their values reduced. This can function as a memory for a given actor.

### REFERENCED MATERIAL

Cormen, Thomas H., and Charles E. Leiserson. Introduction to Algorithms, 3rd Edition. 2009.
Gevin, Gurney. An Introduction to Neural Networks. UCL Press, 1997.
Norvig, Peter and Stuart Russell. Artificial Intelligence: A Modern Approach, Third Edition. 2010.

### DESCRIPTION

The core of this invention is the concept of the “path stack.” This is a set of values that are stored for a given cell within a given space. The set of values can be represented by any data structure that a specific value can be referenced from; this will typically be an array or a hash table. The space may be any space that can be abstracted either to cells in an array or some structure of given coordinates. A given space may have any number of dimensions so long as how the cells or coordinates can be ordered in such a way that the movement rules of the space may be intuited.

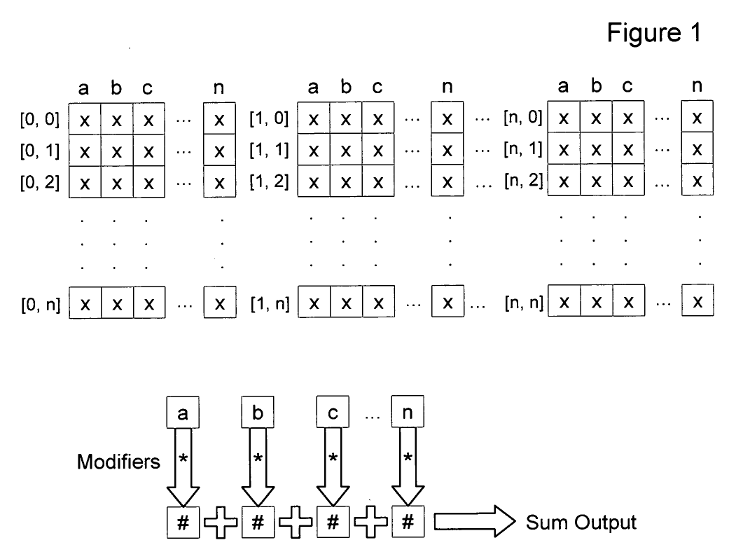

The array implementation of a path stack is an array of predetermined size where each element corresponds to a specific layer. The hash table implementation treats the layer name as the key. An abstract illustration of how a set of path stacks for a two-dimensional array implementation of arbitrary size is included in FIG. 1. A two-dimensional array was chosen for ease of illustration.

A typical space will be a game environment of a known size separated into discrete tiles. This may have any number of dimensions; typically it will be 2D or 3D. However it is also possible to use the algorithm with a more abstract space; in this case a hash table referenced by coordinates is used. In either case the default value of a layer within the stack is zero. This indicates that there is nothing affecting that layer of the given cell's stack.

Any relevant information can be represented by a layer within the stack; this can vary greatly depending on the use of the algorithm as well as the space the actor is existing within. Typical layers include measuring the danger level of a given area, the amount of resources in an area, and which areas are closer to any given goal. Anything that can be rated positively or negatively can have a layer assigned to it. The number of layers can also expand or contract as necessary for the given application; all that is relevant is that the information may be abstracted into ratings. The following are merely examples; the algorithm is not restricted to these layers alone.

Danger Layer—Any cells that are hazardous are rated negatively. The more hazardous the cell the more negative this layer becomes. Any cells that are not hazardous themselves but are near hazards are rated as hazardous; typically less than actually hazardous cells.

Resource Layer—Any cells that posses resources that are desirable are rated positively. Similar to danger cells these can be rated less so for cells that are near a resource. Cells that are far away can be rated negatively or merely remain at zero.

Territory Layer—Any cell that is friendly territory is positively rated. Any hostile territory receives a negative value.

Actor Layer—Cells that are in proximity to other actors that the actor wishes to be near are rated positively. Cells that are in proximity to other actors the actor wishes to avoid are rated negatively.

Goals Layer—Cells that are closer to a given goal are rated more positively than ones that are further away. This can be used to track multiple goals and move generally toward them rather than focusing only on one.

Movement Cost Layer—If some cells are more difficult to move through than others they may be given a lower rating than easier cells.

Curiosity Layer—Any cell that has been visited previously receives a negative modifier that decays over time. This can be used to encourage actors to explore as well as prevent actors from getting stuck repeating the same movements.

Patrol Layer—Any cells that the actor is meant to patrol are rated positively. Cells that are considered too far from the path or patrolled by another actor are rated negatively.

Known Paths Layer—Any paths calculated using another path finding algorithm or that have been recorded have their cells rated positively.

Reinforcement Layer—Any cells that have led to a positive outcome, using traditional reinforcement techniques of neural networks, will be rated appropriately.

Layers may also be shared among actors or external actors may modify the values of an actor's path stack. This allows actors to share information. This may also be used to create a group of actors that all act as if they have one mind. Alternatively all actors in a given space can reference the same set of layers to save on physical memory.

Layers that rely on perception can be fed information as the actor receives. It is also possible to give actors perfect information of the space if it is available. This will of course vary on the requirements of the implementation.

Each layer is multiplied by modifiers as desired. These may be anything conceivable that would make a given layer more or less important for a given situation. If the multiplier is set to one then it has no effect on the layer. A modifier of zero negates the effect entirely. A multiplier above one amplifies the effect of the layer in decision making or path calculating. A modifier greater than zero or less than one reduces its effect. A negative modifier may be used to invert the effect of a given layer The following are merely examples; anything that can be abstracted to a multiplier to a given layer could be used.

Personality Modifiers—These in particular are helpful in a situation where one set of AI code is to be created; the numbers passed to each actor can be the same but multiplied depending on the given personality modifiers. These are modifiers that are applied to a given layer to make it have heavier or lesser effect as desired. For example a cowardly creature would be given a modifier greater than one for the danger layer; the higher the number the less likely the actor is to place itself within a dangerous cell.

Situation Modifiers—Any given actor must act differently depending on the situation. This can cause the actor to amplify the effect of a layer, reduce it, or eliminate it entirely. For example an actor that wishes to retreat at all costs could ignore or reduce the danger layer while rate a layer of safe territory much more highly.

Variable Modifiers—Modifiers that are calculated based on external variables can be applied to various layers. For example in a game where each actor's health is measured by hit points could modify the danger layer in proportion to how many hit points the actor is missing. This would cause damaged actors to move more cautiously.

Task Modifiers—If one actor receives a task from another actor any layer relevant to completing that task

The values and modifiers are floating point values of any desired precision. Complex numbers could be used as well as real numbers.

Unpredictability may be added to applying “irrationality” modifiers. These may either be additive modifiers randomly applied to each path stack, random multipliers applied to the whole stack, or random multipliers applied to each individual layer. For example each path stack could be modified by a random number between −n and n for any given number n. Greater numbers of n would create increasingly random behavior. The size of n in relation to the possible values of any given path stacks determines the amount of randomness in this case. A very large value of n in comparison would create extremely erratic behavior. A small value of n would create occasional deviant behavior while a more moderate value would create randomness that only sometimes overrides rational behavior. In any event if the standard numbers are strong enough they will generally override any given irrationality.

Calculation of each individual path stack begins with calculating the modified value of each layer. The base value is multiplied by any modifiers that apply. Once these are calculated the end results are summed and the total value returned. This gives each cell a given value. It is possible to calculate the entire space all at once though at times this will not be practical or desirable. A smaller set of values can be calculated if desired. For example if only a 20×20 area of a given array of cells is relevant to the decisions being made then only those are calculated and returned as an array of values.

The cells are then compared to each other depending on what is relevant for the given situation. The potential uses are quite extensive; following are a few examples but are by no means the only possible uses.

If the actor is to move to an adjacent cell it calculates which neighboring cell has the highest value and moves to it.

If the actor may move directly to any cell within a given range then all cells within that range have their values calculated. Whichever cell is rated the highest is then moved to.

If the actor must calculate a path of arbitrary length then it must calculate all cells within that range. It then plots a path that begins with the highest rated neighboring cell, proceeds to the highest rated cell next to that that has not been visited, and proceeds until the goal has been reached. It then uses this to plot a plan of movement.

An actor may also use the ratings to calculate multiple paths. It may begin by calculating the best path then, ignoring cells along that path unless no other options exist, calculate the next best value from there. Alternately it may choose a lesser rated neighboring cell, proceed through a few less desirable cells, and the continue to the best from there.

Fuzzy, non-specific paths may also be created. In this case multiple potential cells are chosen as a potential path rather than one specific node. It is also possible in this case to start with specific nodes then spread out from there; for example choosing an immediate neighbor, another immediate neighbor, and then two cells for each neighbor from there.

Calculating path stacks is also useful in a decision making algorithm. As the layers may be used to store information the sum of the cells in a given area around the actor can be calculated and then summed to give an indication of the status of an area. For example layers that store information on hostile actors or hazards could be totaled to determine how much danger the actor is in. In the above example of this being amplified as the actor becomes injured this could be used to determine if the actor attempts to retreat from hazards or not.

The potential uses for the calculated values of the path stacks are myriad. Describing them all is far beyond the scope of this document.

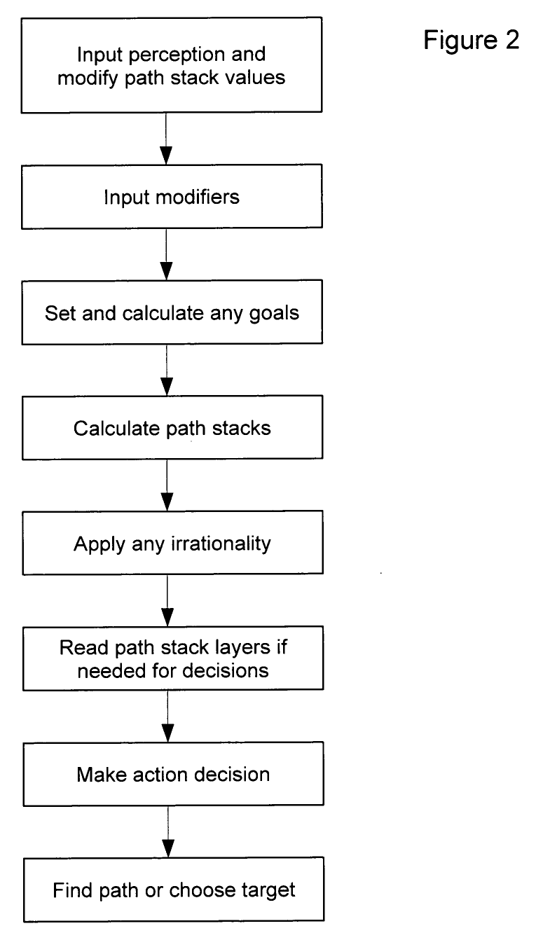

FIG. 2 outlines a typical series of instructions for using the path stack.

### FIG. 1

Each “x” represents a value in the path stack. The variables a, b, c . . . n represent the layers. Each set of coordinates has a path stack represented by the “x” variables aligned with the layers. A two-dimensional set of coordinates is used with simple layer names for purposes of illustration only; coordinates of any number of dimensions may be used while any layer names as appropriate may be chosen.

Each value within the stack is modified by a variety of modifiers as appropriate as described in this document. For each individual path stack the sum indicates the desirability of the coordinates. This is the sum output of the path stack.

### FIG. 2

This is an outline of a typical order of instructions for a typical implementation of this algorithm.

1- The “path stack” path finding concept.

2- The use of various modifiers to alter the values of the various layers within the path stack to influence the outcome.

3- Using the path stack concept to affect decision making algorithms.
